(19) United States
(12) Patent Application Publication
(10) Pub. No.: US 2016/0349470 A1
(43) Pub. Date: Dec. 1, 2016

(54) HYBRID INTEGRATED OPTICAL SUB-ASSEMBLY

(71) Applicant: ELASER TECHNOLOGIES CO.,LTD., New Taipei City (TW)

(72) Inventor: Chu-Liang Cheng, New Taipei City (TW)

(21) Appl. No.: 14/846,826

(22) Filed: Sep. 7, 2015

(30) Foreign Application Priority Data
May 27, 2015 (TW) 104117002

(51) Int. Cl. G02B 6/42; G02B 6/122

(52) U.S. Cl. CPC G02B 6/4249; G02B 6/122; G02B 6/4204; G02B 6/4285; G02B 6/4298; G02B 6/4246

(57) ABSTRACT

A hybrid integrated optical sub-assembly including a substrate, a shell, an optical processing unit, and a plurality of photoelectric conversion elements is provided. The shell is disposed on the substrate and includes a frame and a beam connected to the frame. The frame has at least one first lens element, and the beam has at least one second lens element. The optical processing unit is located between the at least one first lens element and the at least one second lens element. The photoelectric conversion elements are disposed on the substrate, and the at least one second lens element is located between the optical processing unit and the photoelectric conversion elements.

### CROSS REFERENCE TO RELATED APPLICATION

This application claims the priority benefit of Taiwan application serial no. 104117002, filed on May 27, 2015. The entirety of the above-mentioned patent application is hereby incorporated by reference herein and made a part of specification.

### BACKGROUND OF THE INVENTION

Field of the Invention

The invention relates to a hybrid integrated optical sub-assembly.

Description of Related Art

With the advances in communication technology, communication methods are no longer limited to the use of electrical signals. Optical communication technology achieving signal transmission via optical signals has recently been developed. Since the speed of transmission and the distance of light are far greater than those of electrons, optical communication has gradually become the market mainstream.

Due to demands of high bandwidth, demands for an optical transceiver module capable of transmitting a large amount of optical signals have increased as a result. An optical transceiver module is mainly composed of a plurality of photoelectric conversion elements, a plurality of optical components, and a circuit board. In general, the photoelectric conversion elements are first packaged into transmitter outline CAN (TO-CAN), and then fixed with a fiber coupling mechanism to form an optical sub-assembly, the optical sub-assembly is disposed on the circuit board. Moreover, optical components such as a multiplexer (MUX) and a de-multiplexer (de-MUX) are also first packaged into customized packages, and then combined with an optical sub-assembly and disposed on the circuit board.

Since the volume of an element is increased after packaging, the volume of the optical transceiver module formed by the packaged element assembly is often too large, and therefore, it is difficult to place the optical transceiver module into a small case complied with the MSA (multi-source agreement). With increasing demand of bandwidth, and with limited server cabinet space, how to reduce the volume of each of the elements, components, and the integrated optical transceiver module has become one of the important topics in the field.

### SUMMARY OF THE INVENTION

The invention provides a hybrid integrated optical sub-assembly having a small volume.

A hybrid integrated optical sub-assembly of the invention includes a substrate, a shell, an optical processing unit, and a plurality of photoelectric conversion elements. The shell is disposed on the substrate and includes a frame and a beam connected to the frame. The frame has at least one first lens element, and the beam has at least one second lens element. The optical processing unit is located between the at least one first lens element and the at least one second lens element. The photoelectric conversion elements are disposed on the substrate, and the at least one second lens element is located between the optical processing unit and the photoelectric conversion elements.

In an embodiment of the invention, the substrate is a printed circuit board, a ceramic substrate, or a metal composite material substrate.

In an embodiment of the invention, the substrate has a circuit thereon, and the hybrid integrated optical sub-assembly further includes an integrated circuit and an electrical component electrically connected to the circuit.

In an embodiment of the invention, the substrate includes a plurality of alignment structures.

In an embodiment of the invention, the frame and the beam of the shell are one piece.

In an embodiment of the invention, the frame has a first alignment structure. The beam has a second alignment structure. The first alignment structure and the second alignment structure have complementary shapes, and the frame and the beam are assembled together via the first alignment structure and the second alignment structure.

In an embodiment of the invention, the material of the shell is engineering plastic (Ultem).

In an embodiment of the invention, the shell further includes an upper cover. The frame and the beam are located between the upper cover and the substrate, and the optical processing unit is disposed on the substrate or the upper cover.

In an embodiment of the invention, the upper cover, the frame, and the beam are one piece.

In an embodiment of the invention, the upper cover is removably disposed on the frame and the beam.

In an embodiment of the invention, the material of the upper cover includes metal.

In an embodiment of the invention, the optical processing unit is indirectly disposed on the substrate via a carrier.

In an embodiment of the invention, the carrier, the frame, and the beam are one piece.

In an embodiment of the invention, the first lens element is a lenticular lens or a plano-convex lens, and the second lens element is a lenticular lens or a plano-convex lens.

In an embodiment of the invention, the number of the at least one first lens element is one, and the number of the at least one second lens element is N. The photoelectric conversion elements include an N number of light-emitting units and an N number of power-detecting elements, wherein each of the light-emitting units is respectively located between one of the second lens elements and one of the power-detecting elements. The light-emitting units emit an N number of beams. The wavelengths of the N number of beams are different. The optical processing unit is adapted to merge the N number of beams into a first beam and transmit the first beam to the first lens element. The optical processing unit includes at least one reflection unit and an N number of beam splitting units, and each of the beam splitting units is respectively located between the at least one reflection unit and one of the second lens elements, wherein N is an integer greater than 1.

In an embodiment of the invention, the number of the at least one first lens element is one, and the number of the at least one second lens element is N. The photoelectric conversion elements include an N number of light-detecting elements, and each of the second lens elements is respectively located between the optical processing unit and one of the light-detecting elements. A second beam entering the hybrid integrated optical sub-assembly and containing different wavelengths is transmitted to the optical processing unit via the first lens element. The optical processing unit is adapted to split the second beam into an N number of sub-beams having different wavelengths and respectively transmit each of the sub-beams to one of the second lens elements. The optical processing unit includes at least one reflection unit and an N number of beam splitting units, and each of the beam splitting units is respectively located between the at least one reflection unit and one of the second lens elements, wherein N is an integer greater than 1.

In an embodiment of the invention, the number of the at least one first lens element is N, and the number of the at least one second lens element is 2N. The photoelectric conversion elements include an N number of light-emitting units, an N number of power-detecting elements, and an N number of light-detecting elements. The N number of light-emitting units are disposed corresponding to an N number of second lens elements, and the N number of light-detecting elements are disposed corresponding to another N number of second lens elements. Each of the light-emitting units is respectively located between one of the power-detecting elements and one of the N number of second lens elements, and each of the other N number of second lens elements is respectively located between the optical processing unit and one of the light-detecting elements, wherein the N number of light-emitting units emit an N number of first beams, and the N number of first beams are emitted from the hybrid integrated optical sub-assembly via the corresponding N number of second lens elements, the optical processing unit, and the N number of first lens elements in order. An N number of second beams enter the hybrid integrated optical sub-assembly and are transmitted to the N number of light-detecting elements via the N number of first lens elements, the optical processing unit, and the other N number of second lens elements in order. The wavelengths of the N number of second beams are different from wavelengths of the N number of first beams. The optical processing unit includes an N number of beam splitting units, and the N number of beam splitting units are adapted to make the N number of first beams pass through and reflect the N number of second beams, or the N number of beam splitting units are adapted to make the N number of second beams pass through and reflect the N number of first beams, wherein N is an integer greater than or equal to 1.

In an embodiment of the invention, the optical sub-assembly further includes one or an N number of optical isolation units, wherein the N number of second beams from the N number of beam splitting units are transmitted to the N number of light-detecting elements after passing through the one or N number of optical isolation units.

In an embodiment of the invention, the hybrid integrated optical sub-assembly further includes an N number of optical isolation units and an N number of carriers. Each of the carriers has a first fixing groove, a second fixing groove, a connection hole, and a reflection surface. The first fixing groove houses one of the beam splitting units and the second fixing groove houses one of the optical isolation units. The connection hole connects the first fixing groove and is located between the first fixing groove and one of the first lens elements, wherein the second beam from one of the first lens elements passes through the connection hole and is transmitted to one of the beam splitting units housed in the first fixing groove, then is reflected by one of the beam splitting units and the reflection surface in order and transmitted to the optical isolation unit housed in the second fixing groove, and then passes through the optical isolation unit and the corresponding second lens element in order and is transmitted to the corresponding light-detecting element.

In an embodiment of the invention, the material of the N number of carriers is engineering plastic (Ultem).

In an embodiment of the invention, the number of the at least one first lens element is one, and the number of the at least one second lens element is one. The photoelectric conversion elements include a light-emitting unit, a power-detecting element, and a light-detecting element. The light-emitting unit is located between the second lens element and the power-detecting element. The shell further includes an upper cover. The upper cover is removably disposed on the frame and the beam, and the frame and the beam are located between the upper cover and the substrate, wherein the upper cover has a reflection surface and a third lens element located between the reflection surface and the light-detecting element. The light-emitting unit emits a first beam. The first beam is emitted from the hybrid integrated optical sub-assembly via the second lens element, the optical processing unit, and the first lens element in order. The second beam enters the hybrid integrated optical sub-assembly, and the second beam passes through the first lens element and the optical processing unit in order, is reflected by the reflection surface, and then passes through the third lens element and is transmitted to the light-detecting element.

In an embodiment of the invention, the optical sub-assembly further includes a metal plate and a fiber coupling mechanism. The metal plate is fixed to a side of the frame having the at least one first lens element. The metal plate has at least one through-hole. The at least one through-hole exposes the at least one first lens element. The optical fiber coupling mechanism is fixed to the metal plate.

In an embodiment of the invention, the optical fiber coupling mechanism is a connector receptacle or a connector receptacle array.

In an embodiment of the invention, the optical fiber coupling mechanism is a fiber tail or a fiber tail array.

In an embodiment of the invention, the optical fiber coupling mechanism is a fiber tail array. The hybrid integrated optical sub-assembly further includes a fiber array connector connecting the fiber tail array.

Based on the above, in an embodiment of the invention, since the photoelectric conversion elements are disposed on the substrate, an additional packaging process of the photoelectric conversion elements may be omitted. As a result, the volume of the hybrid integrated optical sub-assembly can be effectively reduced, thus facilitating the reduction in manufacturing costs. Moreover, since the lens elements (including the first lens elements and the second lens elements) and the shell are one piece, alignment of conventional separate lens elements with one another and an assembly process are not needed, thus facilitating the reduction in the number and the difficulty of optical path correction.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is an exploded view of a hybrid integrated optical sub-assembly according to the first embodiment of the invention.

FIG. 1B is a top view of FIG. 1A.

FIG. 1C is a cross-sectional view along the section line A-A′ in FIG. 1B.

FIG. 2A is an exploded view of a hybrid integrated optical sub-assembly according to the second embodiment of the invention.

FIG. 2B is a top view of FIG. 2A.

FIG. 2C is a cross-sectional view along the section line B-B′ in FIG. 2B.

FIG. 3A is an exploded view of a hybrid integrated optical sub-assembly according to the third embodiment of the invention.

FIG. 3B is a top view of FIG. 3A.

FIG. 3C and FIG. 3D are respectively cross-sectional views along the section lines C-C′ and D-D′ in FIG. 3B.

FIG. 4A is an exploded view of a hybrid integrated optical sub-assembly according to the fourth embodiment of the invention.

FIG. 4B is a top view of FIG. 4A.

FIG. 4C and FIG. 4D are respectively cross-sectional views along the section lines E-E′ and F-F′ in FIG. 4B.

FIG. 5A is an exploded view of a hybrid integrated optical sub-assembly according to the fifth embodiment of the invention.

FIG. 5B is a top view of FIG. 5A.

FIG. 5C is a cross-sectional view along the section line G-G′ in FIG. 5B.

FIG. 6A is an exploded view of a hybrid integrated optical sub-assembly according to the sixth embodiment of the invention.

FIG. 6B is a top view of FIG. 6A.

FIG. 6C is a cross-sectional view along the section line H-H′ in FIG. 6B.

### DESCRIPTION OF THE EMBODIMENTS

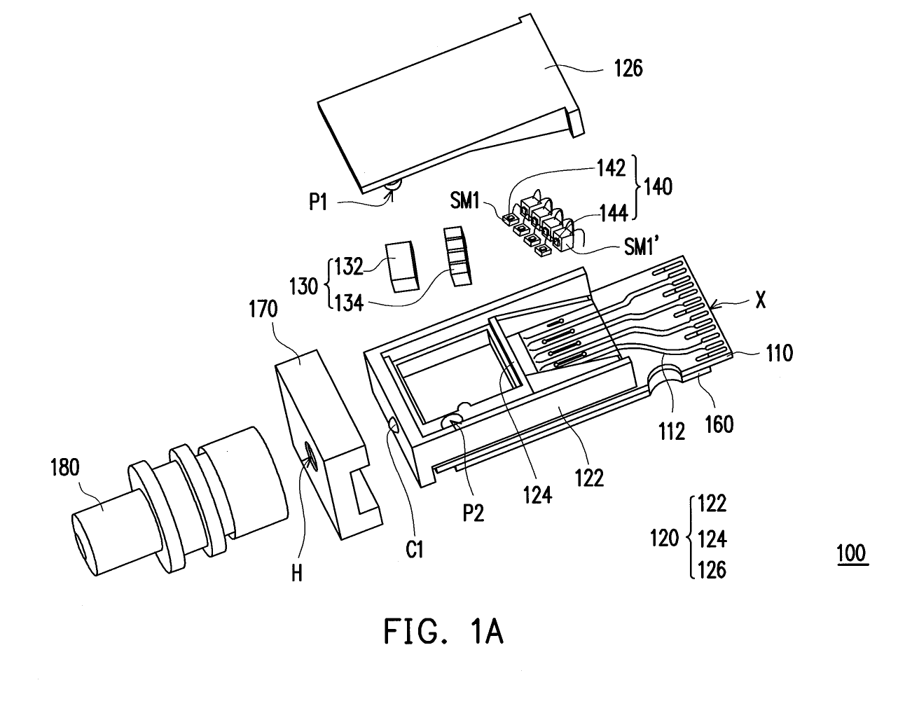

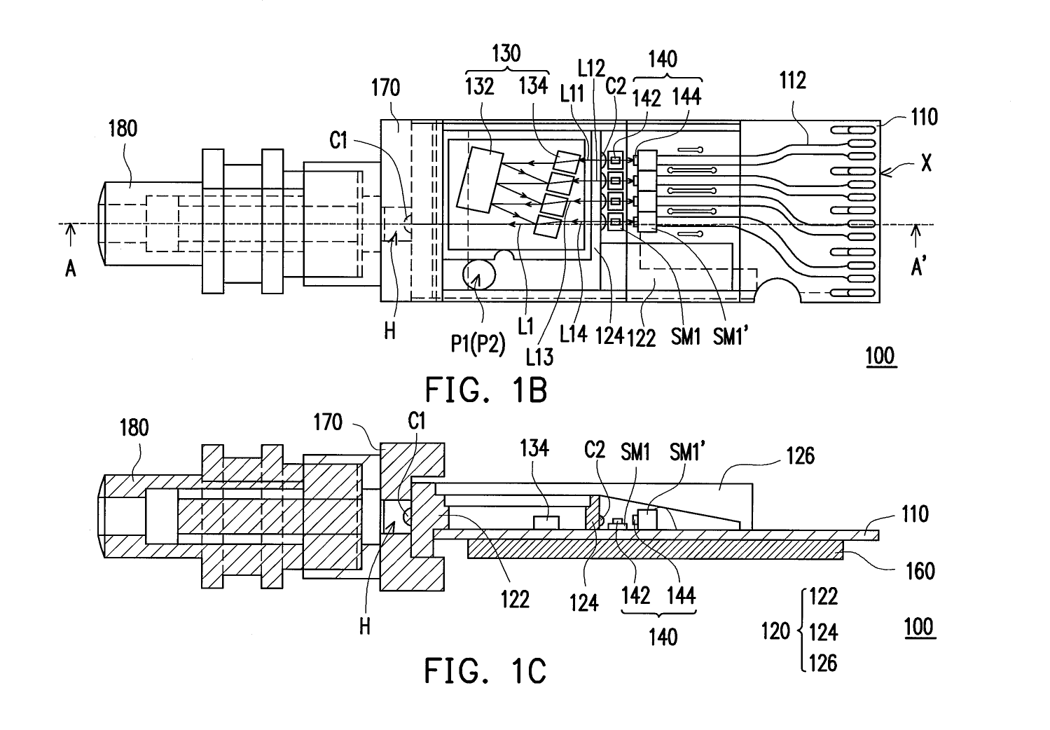

FIG. 1A is an exploded view of a hybrid integrated optical sub-assembly according to the first embodiment of the invention. FIG. 1B is a top view of FIG. 1A, wherein FIG. 1B does not show the upper cover in FIG. 1A so as to clearly show elements located below the upper cover. FIG. 1C is a cross-sectional view along the section line A-A′ in FIG. 1B. Referring to FIG. 1A to FIG. 1C, a hybrid integrated optical sub-assembly 100 includes a substrate 110, a shell 120, an optical processing unit 130, and a plurality of photoelectric conversion elements 140.

The substrate 110 is a printed circuit board, a ceramic substrate, a metal complex material substrate, or other substrates adapted for carrying elements and on which a circuit can be disposed, wherein the ceramic substrate can be an Al₂O₃ substrate or an aluminum nitride substrate. A circuit 112 for signal transmission (such as an electric signal) can be disposed on the substrate 110. The circuit 112 is electrically connected to the photoelectric conversion elements 140, and the circuit 112 is extended to an edge X of the substrate 110 from a disposition region of the photoelectric conversion elements 140, so as to be connected to an external circuit (not shown).

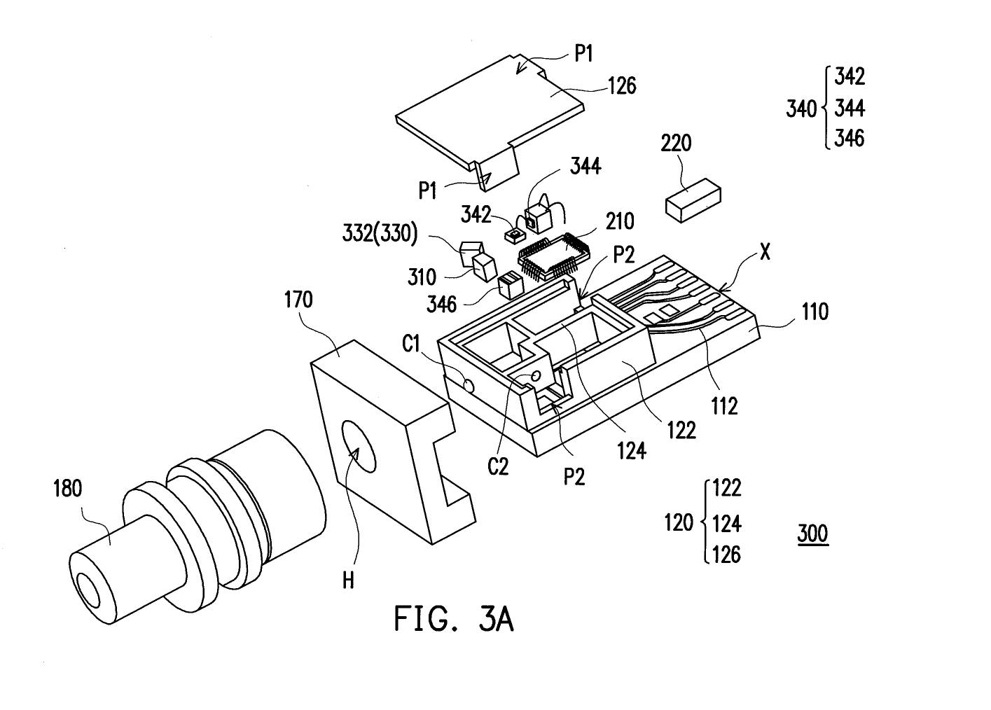

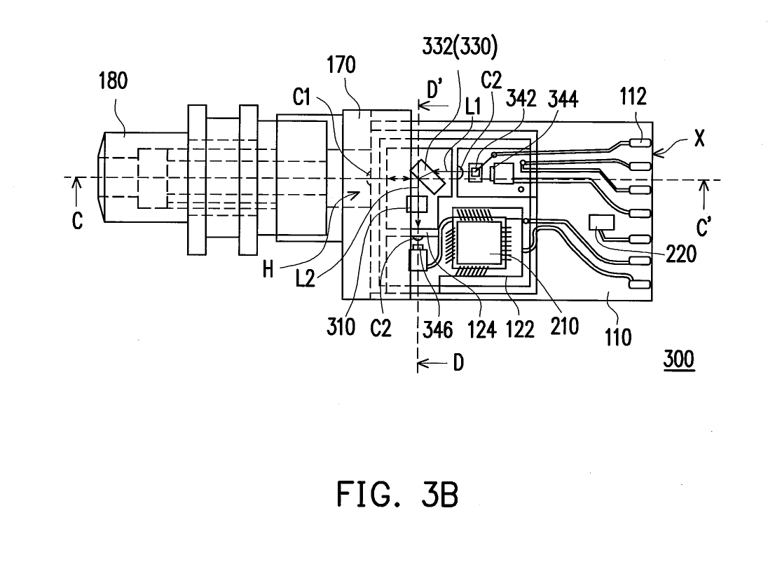

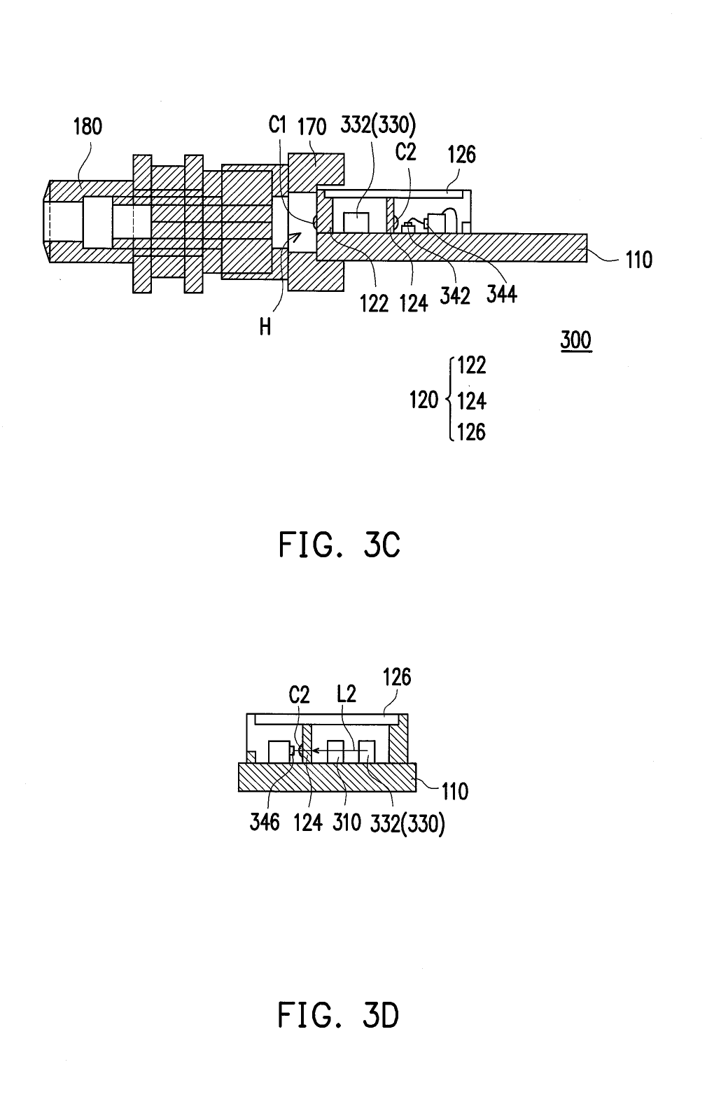

According to different design requirements, the hybrid integrated optical sub-assembly 100 can further include an integrated circuit and an electrical component which are not shown (such as an integrated circuit 210 and an electrical component 220 in FIG. 3A and FIG. 3B). The integrated circuit, the electrical component, and the circuit 112 are electrically connected to one another. In the present embodiment, the integrated circuit can be, for instance, an integrated circuit of a laser driver or an optical transceiver module, and the electrical component can be a passive element such as a resistor or a capacitor, etc.

The shell 120 is disposed on the substrate 110 and includes a frame 122 and a beam 124 connected to the frame 122. The frame 122 and the beam 124 can be one piece. For instance, the frame 122 and the beam 124 can be molded together with an engineering plastic (Ultem), but is not limited thereto. In another embodiment, the frame 122 and the beam 124 can also be manufactured separately and then assembled together. In such architecture, the frame 122 can have a first alignment structure (not shown), and the beam 124 can have a second alignment structure (not shown). The first alignment structure and the second alignment structure have complementary shapes, such that the frame 122 and the beam 124 can be assembled together via the first alignment structure and the second alignment structure. For instance, one of the first alignment structure and the second alignment structure can be an alignment pin, and the other of the first alignment structure and the second alignment structure can be an alignment groove, but are not limited thereto. In other embodiments, the frame 122 can also be a combination frame, and the beam 124 can also be a combination beam.

The frame 122 has a first lens element C1, and the beam 124 has a plurality of second lens elements C2. The frame 122 having the first lens element C1 means the first lens element C1 is a portion of the frame 122, that is, the first lens element C1 and the other portions of the frame can be integrally formed (i.e. the first lens element C1 and the other portions of the frame can be one piece). When the frame 122 is a combination frame, the portion of the frame 122 connected to the first lens element C1 and the first lens element C1 can be one piece. Similarly, the beam 124 having a plurality of second lens elements C2 means the second lens elements C2 are a portion of the beam 124, that is, the second lens elements C2 and the other portions of the beam 124 can be integrally formed (i.e. the second lens elements C2 and the other portions of the beam 124 can be one piece). When the beam 124 is a combination beam, the portion of the beam 124 connected to the second lens elements C2 and the second lens elements C2 can be one piece.

The first lens element C1 and the second lens elements C2 are adapted to converge or collimate a beam. As shown in FIG. 1B, the first lens element C1 is located at a side of the frame 122 parallel to the edge X, and the first lens element C1 is, for instance, a plano-convex lens for which the convex surface is relatively far away from the edge X. The arrangement direction of the second lens elements C2 is also parallel to the edge X, and each of the second lens elements C2 is, for instance, a plano-convex lens for which the convex surface is relatively close to the edge X. However, the individual configurations and relative positions of the first lens element C1 and the second lens elements C2 can be changed according to design requirements, and are not limited to the illustration of FIG. 1B. For instance, the first lens element C1 and the second lens elements C2 can also respectively be lenticular lenses. Moreover, the first lens element C1 and the second lens elements C2 can respectively be spherical lenses or aspheric lenses.

The optical processing unit 130 is located between the first lens element C1 and the second lens elements C2 so as to process a beam transmitted between the first lens element C1 and the second lens elements C2. According to different design requirements, the optical processing unit 130 can be configured to merge multi-wavelength light, split multi-wavelength light, or for multi-wavelength bi-directional optical transmission. As shown in FIG. 1B, the hybrid integrated optical sub-assembly 100 can be a transmitter optical sub-assembly (TOSA), and the optical processing unit 130 can be configured to merge multi-wavelength light. Specifically, a plurality of sub-beams L11, L12, L13, and L14 having different wavelengths from the photoelectric conversion elements 140 are first collimated via the second lens elements C2, and then transmitted to the optical processing unit 130. The optical processing unit 130 is adapted to merge the sub-beams L11, L12, L13, and L14 having different wavelengths into a first beam L1 and transmit the first beam L1 to the first lens element C1. The first lens element C1 can then converge the first beam L1 from the optical processing unit 130 into a coupling fiber (not shown) of the hybrid integrated optical sub-assembly 100.

The optical processing unit 130 can include at least one reflection unit 132 and a plurality of beam splitting units 134, wherein the beam splitting units 134 are located between the reflection unit 132 and the photoelectric conversion elements 140, and each of the beam splitting units 134 is respectively located between the reflection unit 132 and one of the second lens elements C2. Each of the beam splitting units 134 is adapted to make a sub-beam having a specific wavelength (one of the sub-beams L11, L12, L13, and L14) from the corresponding second lens element C2 pass through and reflect sub-beams having other wavelengths (other three of the sub-beams L11, L12, L13, and L14). For instance, each of the beam splitting units 134 can be a dichroic filter, but is not limited thereto. The reflection unit 132 is disposed on transmission paths of the sub-beams L11, L12, and L13 passing through the beam splitting unit 134, such that the sub-beams L11, L12, and L13 are transmitted to the first lens element C1 via the reflection of the reflection unit 132 and at least one of the beam splitting units 134. For instance, after the sub-beam L11 passes through the corresponding beam splitting unit 134, the sub-beam L11 is reflected by the reflection unit 132, the beam splitting unit 134 making the sub-beam L12 pass through, the reflection unit 132, the beam splitting unit 134 making the sub-beam L13 pass through, the reflection unit 132, and the beam splitting unit 134 making the sub-beam L14 pass through in order, and then the sub-beam L11 is transmitted toward the first lens element C1 along the same transmission path as the sub-beam L14. The reflection unit 132 can be a reflection mirror, but is not limited thereto. In the present embodiment, the sub-beams L11, L12, and L13 share one reflection unit 132, but the invention is not limited thereto. In another embodiment, the number of the reflection unit 132 can be a plurality, and the reflection units 132 can be respectively disposed corresponding to each of the sub-beams (such as the sub-beams L11, L12, and L13) to be merged.

The photoelectric conversion elements 140 are disposed on the substrate 110, and each of the second lens elements C2 is respectively located between the optical processing unit 130 and the photoelectric conversion elements 140. The photoelectric conversion elements 140 can include a plurality of light-emitting units 142 and a plurality of power-detecting elements 144, wherein each of the light-emitting units 142 is respectively located between one of the second lens elements C2 and one of the power-detecting elements 144. Each of the light-emitting units 142 can be a laser diode (LD) such as a side-emitting laser diode, and each of the light-emitting units 142 can be directly disposed on the substrate 110. Alternatively, as shown in FIG. 1C, each of the light-emitting units 142 can be pre-disposed on a submount SM1, and then the submount SM1 is disposed on the substrate 110. The power-detecting elements 144 is configured to instantly monitor the light intensity of the sub-beam (one of the sub-beams L11, L12, L13, and L14) emitted by the corresponding light-emitting unit 142. For instance, the power-detecting elements 144 can be photodiodes, but are not limited thereto. Each of the power-detecting elements 144 can be pre-disposed on a submount SM1′, and then the submount SM1′ having the power-detecting elements 144 is made to face the light-emitting units and disposed on the substrate 110.

In actual manufacturing process, the circuit 112 can be first manufactured on the substrate 110. Then, the shell 120 and the substrate 110 are bonded. For instance, the shell 120 and the substrate 110 can be adhered to each other via an adhesive layer (not shown). The material of the adhesive layer can be selected from a material without significant thermal expansion effect. After the shell 120 and the substrate 110 are bonded, the optical processing unit 130 and the photoelectric conversion elements 140 are disposed on the substrate 110, and the photoelectric conversion elements 140 and the circuit 112 are electrically connected via a wire bonding process.

It should be mentioned that, the disposition method of the optical processing unit 130 is not limited to the above. For instance, the optical processing unit 130 can be indirectly disposed on the substrate 110 via a carrier (not shown). The carrier can be a substrate independent from the shell 120, and the carrier can be fixed on the substrate 110 via an alignment structure. Alternatively, corresponding alignment structures can be formed on the carrier and the shell 120, and the carrier and the shell 120 are fixed together via the alignment structures. In another embodiment, the carrier can be a portion of the shell 120, wherein the carrier, the frame 122, and the beam 124 can be one piece, and the carrier can be a bottom plate or an upper cover connecting the frame 122 and the beam 124. When the carrier is a bottom plate, the optical processing unit 130 can be pre-disposed on the carrier, and then the shell 120 and the substrate 110 are bonded. In such architecture, the photoelectric conversion elements 140 can be disposed on the substrate 110 before or after the shell 120 and the substrate 110 are bonded. On the other hand, when the carrier is an upper cover, the optical processing unit 130 can be pre-disposed on the carrier, and after the photoelectric conversion elements 140 are disposed on the substrate 110 and electrically connected to the circuit 112, the shell 120 and the substrate 110 are bonded.

Via the disposition of the photoelectric conversion elements 140 on the substrate 110, an additional packaging process is not needed for the photoelectric conversion elements 140. In other words, the photoelectric conversion elements 140 is not needed to be packaged into transmitter outline CAN (TO-CAN). As a result, the volume and the manufacturing costs of the hybrid integrated optical sub-assembly 100 can be effectively reduced. Moreover, since the area occupied by each of the photoelectric conversion elements 140 can be effectively reduced, under the premise of a fixed area of the substrate 110, more photoelectric conversion elements 140 (including the light-emitting units 142 and the power-detecting elements 144) and corresponding optical elements (such as the beam splitting units 134) can be disposed on the substrate 110, such that the light signal transmission capacity per unit area of the hybrid integrated optical sub-assembly 100 can be effectively increased.

In the present embodiment, in addition to forming the circuit 112, a plurality of alignment structures can be pre-formed on the substrate 110, such as an alignment pattern, an alignment line, a slot, or a tenon. As a result, the shell 120, the optical processing unit 130, and the photoelectric conversion elements 140 can be more accurately disposed on a preset region of the substrate 110.

Moreover, the shell 120 can further include an upper cover 126, wherein the frame 122, the beam 124, the optical processing unit 130, and the photoelectric conversion elements 140 are located between the upper cover 126 and the substrate 110. In the present embodiment, the upper cover 126 is removably disposed on the frame 122 and the beam 124. In other words, the manufacture of the upper cover 126 can be separated from the manufacture of the frame 122 and the beam 124. Therefore, the material of the upper cover 126 can be different from the materials of the frame 122 and the beam 124. For instance, the material of the upper cover 126 can include a metal, but is not limited thereto. To facilitate the bonding of the upper cover 126 and the frame 122, corresponding alignment structures P1 and P2 can be respectively formed on the upper cover 126 and the frame 122, wherein the alignment structure P1 is, for instance, a protruding portion, the alignment structure P2 is, for instance, a recess portion capable of housing the alignment structure P1, and the configurations and the dispositions of the alignment structures P1 and P2 are not limited to the illustration of FIG. 1A.

According to different design requirements, the hybrid integrated optical sub-assembly 100 can further include other elements. For instance, the hybrid integrated optical sub-assembly can further include a heat dissipation plate 160. The heat dissipation plate 160 is disposed below the substrate 110 and is in contact with the substrate 110, and is configured to dissipate heat generated during the operation of the hybrid integrated optical sub-assembly 100.

The hybrid integrated optical sub-assembly 100 can further include a metal plate 170 and a fiber coupling mechanism 180. The metal plate 170 is fixed to a side of the frame 122 having the first lens element C1, and the metal plate 170 has a through-hole H. The through-hole H exposes the first lens element C1. After the metal plate 170 and the frame 122 are assembled, the first lens element C1 is housed in the through-hole H. The fiber coupling mechanism 180 is fixed to the metal plate 170, and the two can be tightly fixed together via a welding method. The fiber coupling mechanism 180 is adapted to be coupled to a fiber (not shown). For instance, the fiber coupling mechanism 180 can be a connector receptacle, but is not limited thereto. When the fiber coupling mechanism 180 is fixed to the metal plate 170, optical path correction can be performed to ensure the fiber is aligned with the optical path of the first beam L1 passing through the first lens element C1.

In the assembly process of a conventional optical sub-assembly, when an optical element such as a lens or an optical processing unit and a photoelectric conversion element are disposed, active optical alignment generally needs to be performed. In the present embodiment, since the lens elements (including the first lens element C1 and the second lens elements C2) are integrated on the shell 120, that is, the lens elements and the shell are one piece, and the optical processing unit 130 and the photoelectric conversion elements 140 can be accurately fixed on a preset optical path via passive mechanical alignment, active optical alignment steps of the corresponding lens elements, the optical processing unit 130, and the photoelectric conversion elements 140 can be omitted. In other words, in comparison to prior art, the number and the difficulty of optical path correction can be reduced in the present embodiment.

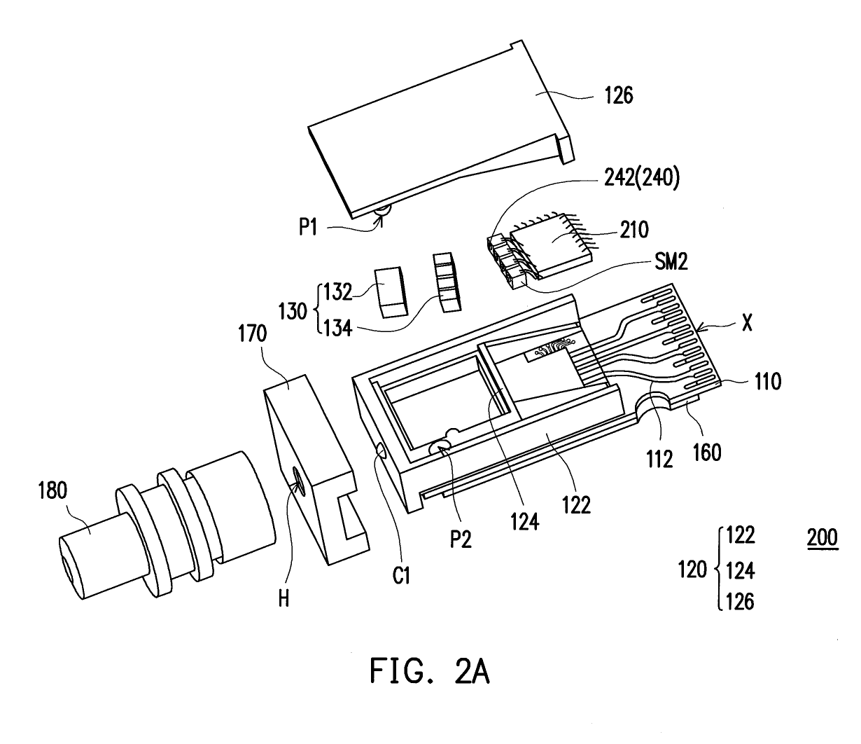

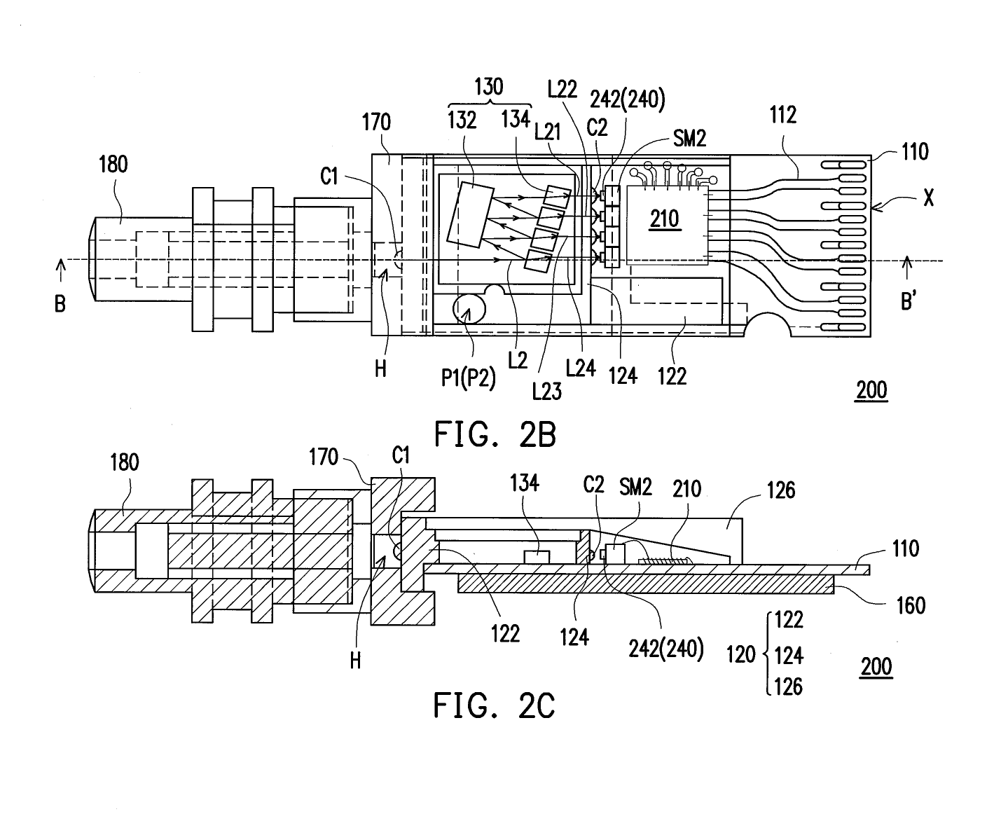

FIG. 2A is an exploded view of a hybrid integrated optical sub-assembly according to the second embodiment of the invention. FIG. 2B is a top view of FIG. 2A, wherein FIG. 2B does not show the upper cover in FIG. 2A so as to clearly show elements located below the upper cover. FIG. 2C is a cross-sectional view along the section line B-B′ in FIG. 2B. Referring to FIG. 2A to FIG. 2C, an optical sub-assembly 200 is similar to the optical sub-assembly 100 of FIG. 1A to FIG. 1C, and similar elements are labeled with the same reference numerals and are not repeated herein.

The main difference between the hybrid integrated optical sub-assembly 200 and the hybrid integrated optical sub-assembly 100 is, the hybrid integrated optical sub-assembly 200 is a receiver optical sub-assembly (ROSA), and the optical processing unit 130 can be configured for multi-wavelength light splitting. As shown in FIG. 2B, the hybrid integrated optical sub-assembly 200 is adapted to receive an external second beam L2 containing a plurality of different wavelengths via a fiber coupled to the fiber coupling mechanism 180, wherein after the second beam L2 enters the optical sub-assembly 200, the second beam L2 is transmitted to the optical processing unit 130 via the first lens element C1. The optical processing unit 130 is adapted to split the second beam L2 into a plurality of sub-beams L21, L22, L23, and L24 having different wavelengths and respectively transmit each of the sub-beams L21, L22, L23, and L24 to one of the second lens elements C2. Each of the second lens elements C2 further converges the corresponding sub-beam (one of the sub-beams L21, L22, L23, and L24) to a corresponding photoelectric conversion element 240. The architecture and the working principle of the optical processing unit 130 are as described above and are not repeated herein.

In the present embodiment, the photoelectric conversion elements 240 include a plurality of light-detecting elements 242, and each of the second lens elements C2 is respectively located between the optical processing unit 130 and one of the light-detecting elements 242. Each of the light-detecting elements 242 can be first disposed on a submount SM2, and then the submount SM2 is disposed on the substrate 110. Moreover, each of the light-detecting elements 242 is respectively electrically connected to the integrated circuit 210. Each of the light-detecting elements 242 can be a photodiode, and the integrated circuit 210 can be an integrated circuit of a trans-impedance amplifier (TIA), a post amplifier, or an optical transceiver IC, but is not limited thereto.

FIG. 3A is an exploded view of a hybrid integrated optical sub-assembly according to the third embodiment of the invention. FIG. 3B is a top view of FIG. 3A, wherein FIG. 3B does not show the upper cover in FIG. 3A so as to clearly show elements located below the upper cover. FIG. 3C and FIG. 3D are respectively cross-sectional views along the section lines C-C′ and D-D′ in FIG. 3B. Referring to FIG. 3A to FIG. 3D, a hybrid integrated optical sub-assembly 300 is similar to the hybrid integrated optical sub-assembly 100 of FIG. 1A to FIG. 1C, and similar elements are labeled with the same reference numerals and are not repeated herein.

The main difference between the hybrid integrated optical sub-assembly 300 and the hybrid integrated optical sub-assembly 100 is, the hybrid integrated optical sub-assembly 300 is a single-channel bi-directional optical sub-assembly. To be specific, the number of the first lens element C1 of the hybrid integrated optical sub-assembly 300 is one, and the number of the second lens element C2 is two, wherein the two second lens elements C2 are respectively disposed at two adjacent sides of the optical processing unit 330. A photoelectric conversion element 340 includes a light-emitting unit 342, a power-detecting element 344, and a light-detecting element 346, wherein the numbers of the light-emitting unit 342, the power-detecting element 344, and the light-detecting element 346 are respectively one, and the light-emitting unit 342 and the light-detecting element 346 are respectively disposed corresponding to different second lens elements C2. Specifically, the light-emitting unit 342 is located between one of the second lens elements C2 and the power-detecting element 344, and the other second lens element C2 is located between the optical processing unit 330 and the light-detecting element 346. In such architecture, the second lens element C2 corresponding to the light-emitting unit 342 and the second lens element C2 corresponding to the light-detecting element 346 can have the same or different designs (such as focus or surface design).

The light-emitting unit 342 is adapted to emit a first beam L1, and the first beam L1 is emitted from the hybrid integrated optical sub-assembly 300 via the corresponding second lens element C2, the optical processing unit 330, and the first lens element C1 in order. A second beam L2 enters the hybrid integrated optical sub-assembly 300 and is transmitted to the light-detecting element 346 via the first lens element C1, the optical processing unit 330, and the other second lens element C2 in order, wherein the wavelength of the second beam L2 is different from the wavelength of the first beam L1. The optical processing unit 330 includes a beam splitting unit 332, and the beam splitting unit 332 is adapted to make the first beam L1 pass through and reflect the second beam L2. In another embodiment, the beam splitting unit 332 can also make the second beam L2 pass through and reflect the first beam L1. In such architecture, the positions of the light-emitting unit 342 (and the power-detecting element 344) and the light-detecting element 346 need to be switched.

The hybrid integrated optical sub-assembly 300 can further include an optical isolation unit 310. The optical isolation unit 310 is adapted to make the second beam L2 pass through and block beams of other wavelengths. The optical isolation unit 310 can be disposed on the transmission path of the second beam L2 from the beam splitting unit 332, such that after the second beam L2 from the beam splitting unit 332 passes through the optical isolation unit 310, the second beam L2 is transmitted to the light-detecting element 346. As a result, absence of interference to the light signal detected by the light-detecting element 346 from stray light can be ensured. For instance, the optical isolation unit 310 can be a filter.

Moreover, the hybrid integrated optical sub-assembly 300 can further include an electrical component 220 electrically connected to the integrated circuit 210 and the circuit 112. The electrical component can be a passive element such as a resistor or a capacitor.

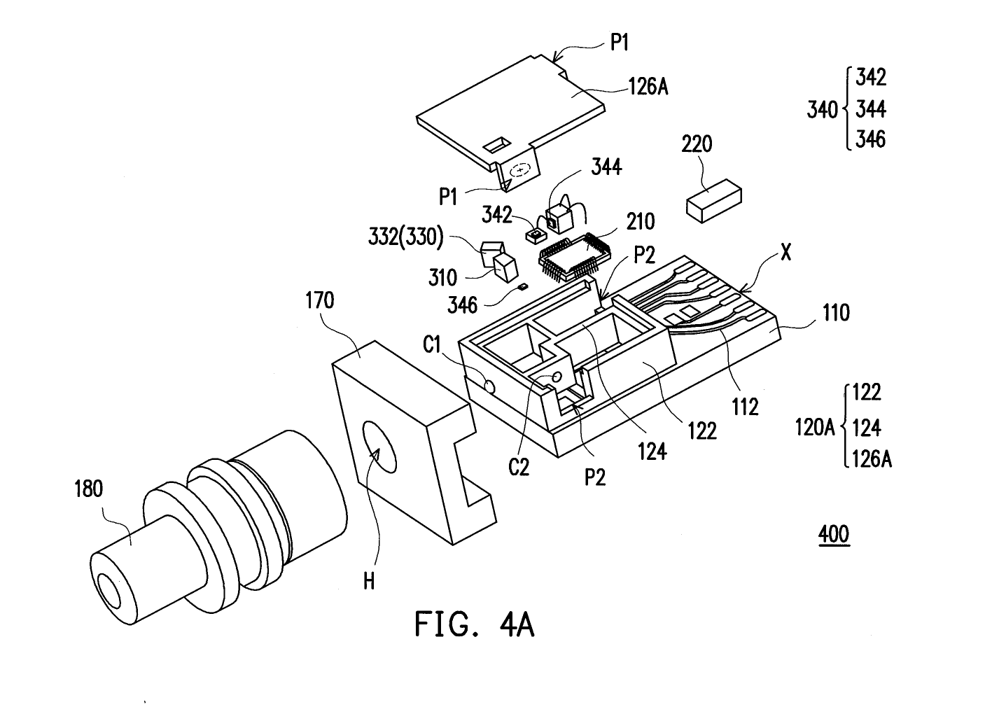

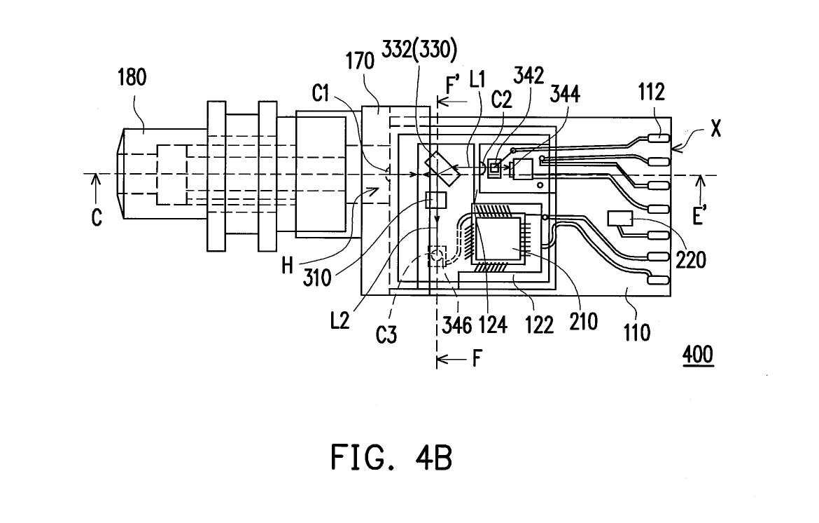

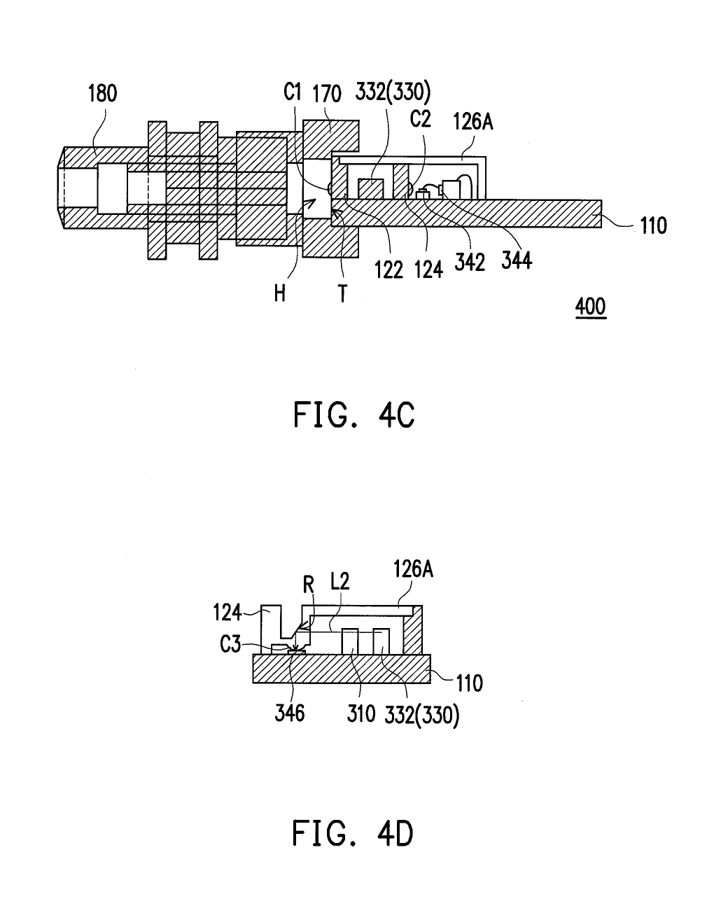

FIG. 4A is an exploded view of a hybrid integrated optical sub-assembly according to the fourth embodiment of the invention. FIG. 4B is a top view of FIG. 4A, wherein FIG. 4B does not show the upper cover in FIG. 4A so as to clearly show elements located below the upper cover. FIG. 4C and FIG. 4D are respectively cross-sectional views along the section lines E-E′ and F-F′ in FIG. 4B. Referring to FIG. 4A to FIG. 4D, a hybrid integrated optical sub-assembly 400 is similar to the hybrid integrated optical sub-assembly 300 of FIG. 3A to FIG. 3D, and similar elements are labeled with the same reference numerals and are not repeated herein.

The main difference between the hybrid integrated optical sub-assembly 400 and the hybrid integrated optical sub-assembly 300 is that the number of the second lens element C2 of the hybrid integrated optical sub-assembly 400 is one, and the upper cover 126A of the shell 120A has a reflection surface R and a third lens element C3 located between the reflection surface R and the light-detecting element 346, wherein the second beam L2 passes through the first lens element C1 and the optical processing unit 330 in order, is reflected by the reflection surface R, and then passes through the third lens element C3 and is transmitted to the light-detecting element 346. The reflection surface R is, for instance, an inclined plane at a 45-degree angle with the substrate 110, and is configured to rotate the second beam L2 transmitted to the inclined plane by 90 degrees, emit the second beam L2 to the third lens element C3, and transmit the second beam L2 to the light-detecting element 346. In the present embodiment, the reflection surface R changes the direction of the second beam L2 via the principle of total reflection, but is not limited thereto.

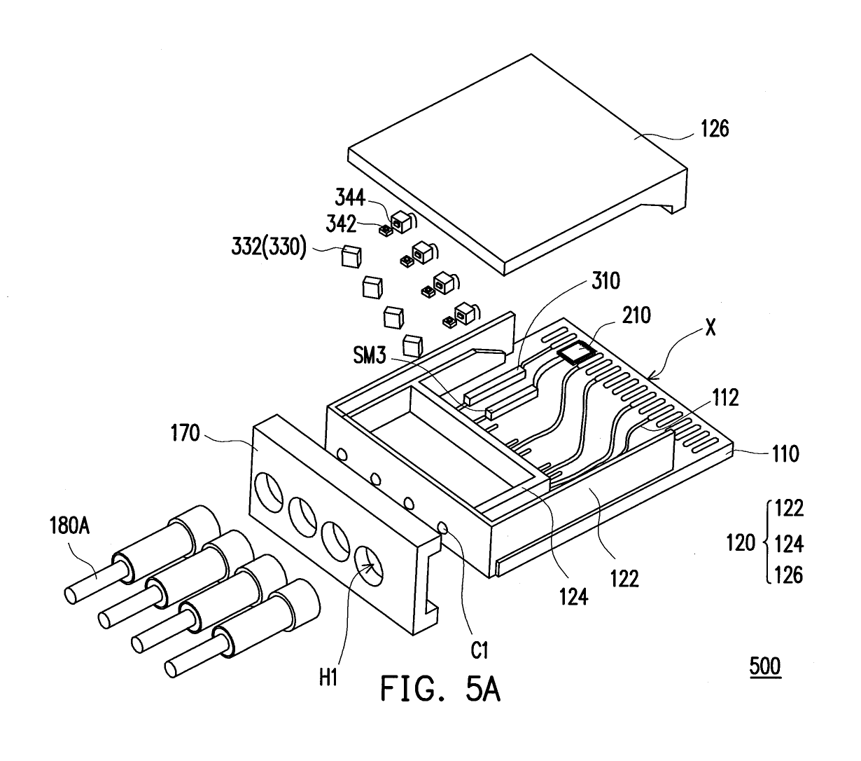

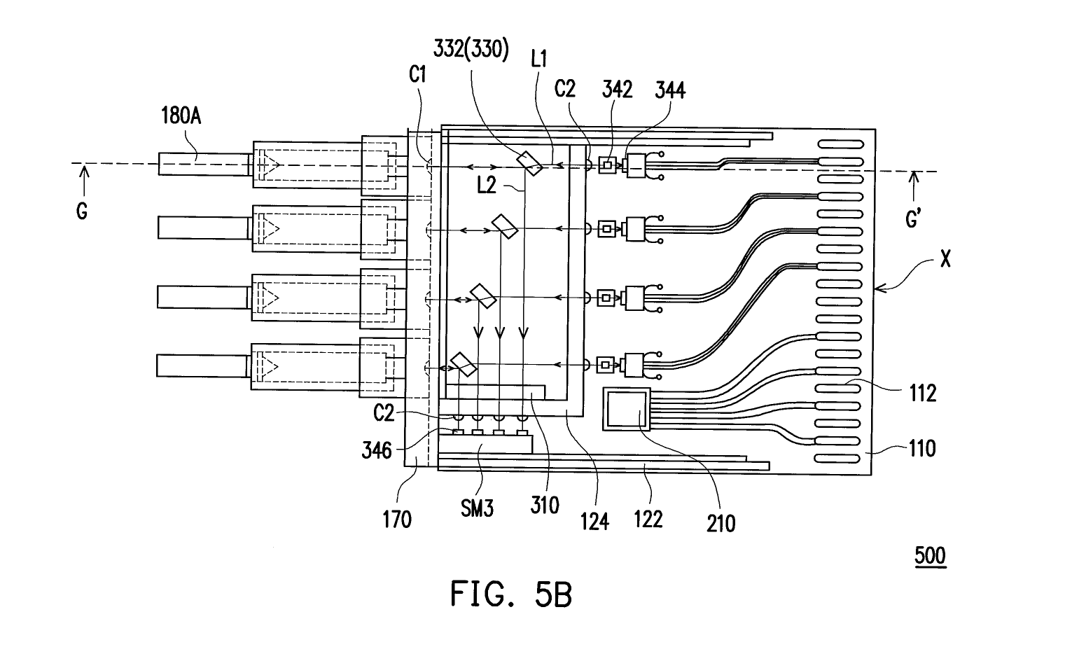

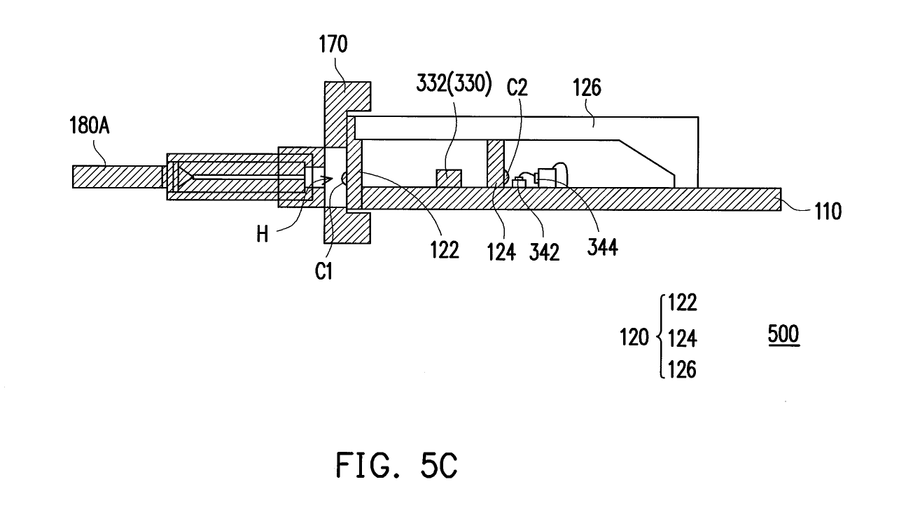

FIG. 5A is an exploded view of a hybrid integrated optical sub-assembly according to the fifth embodiment of the invention. FIG. 5B is a top view of FIG. 5A, wherein FIG. 5B does not show the upper cover in FIG. 5A so as to clearly show elements located below the upper cover. FIG. 5C is a cross-sectional view along the section line G-G′ in FIG. 5B. Referring to FIG. 5A to FIG. 5C, a hybrid integrated optical sub-assembly 500 is similar to the hybrid integrated optical sub-assembly 300 of FIG. 3A to FIG. 3D, and similar elements are labeled with the same reference numerals and are not repeated herein.

The main difference between the hybrid integrated optical sub-assembly 500 and the hybrid integrated optical sub-assembly 300 is, the hybrid integrated optical sub-assembly 500 is a multi-channel bi-directional optical sub-assembly. To be specific, the number of the first lens element C1 is N and the number of the second lens element C2 is 2N. The photoelectric conversion elements 340 include an N number of light-emitting units 342, an N number of power-detecting elements 344, and an N number of light-detecting elements 346. The N number of light-emitting units 342 are disposed corresponding to an N number of second lens elements C2, and the N number of light-detecting elements 346 are disposed corresponding to another N number of second lens elements C2, wherein the N number of second lens elements C2 and the other N number of second lens elements C2 are respectively located at two adjacent sides of the optical processing unit 330. Each of the light-emitting units 342 is respectively located between one of the power-detecting elements 344 and one of the N number of second lens elements C2, and each of the other N number of second lens elements C2 is respectively located between the optical processing unit 330 and one of the light-detecting elements 346. In such architecture, the N number of second lens elements C2 corresponding to the light-emitting units 342 and the other N number of second lens elements C2 corresponding to the light-detecting elements 346 can have the same or different designs (such as focus or surface design).

As shown in FIG. 5B, the N number of light-emitting units 342 emit an N number of first beams L1. The N number of first beams L1 are emitted from the hybrid integrated optical sub-assembly 500 via the N number of corresponding second lens elements C2, the optical processing unit 330, and the N number of first lens elements C1 in order. The N number of second beams L2 enter the hybrid integrated optical sub-assembly 500 and are transmitted to the N number of light-detecting elements 346 via the N number of first lens elements C1, the optical processing unit 330, and the other N number of second lens elements C2 in order. The wavelengths of the N number of second beams L2 are different from the wavelengths of the N number of first beams L1. The optical processing unit 330 includes an N number of beam splitting units 342, and the N number of beam splitting units 342 are adapted to make the N number of first beams L1 pass through and reflect the N number of second beams L2. In another embodiment, the N number of beam splitting units 332 can also make the N number of second beams L2 pass through and reflect the N number of first beams L1. In such architecture, the positions of the light-emitting unit 342 (and the power-detecting element 344) and the light-detecting element 346 need to be switched. N is an integer greater than 1, and is, for instance, 4, but is not limited thereto.

In the present embodiment, the N number of light-detecting elements 346 can be first disposed on a submount SM3, and then the submount SM3 is disposed on the substrate 110. Moreover, the number of the optical isolation unit 310 can be one, or the number of the optical isolation unit 310 can be equal to the number of the light-detecting elements 346. In such architecture, each of the other N number of second lens elements C2 is respectively located between one of the optical isolation units 310 and one of the light-detecting elements 346.

A fiber coupling mechanism 180A can be a fiber tail array, but is not limited thereto. In an embodiment, the hybrid integrated optical sub-assembly 500 can further include a fiber array connector (not shown) connecting the fiber tail array.

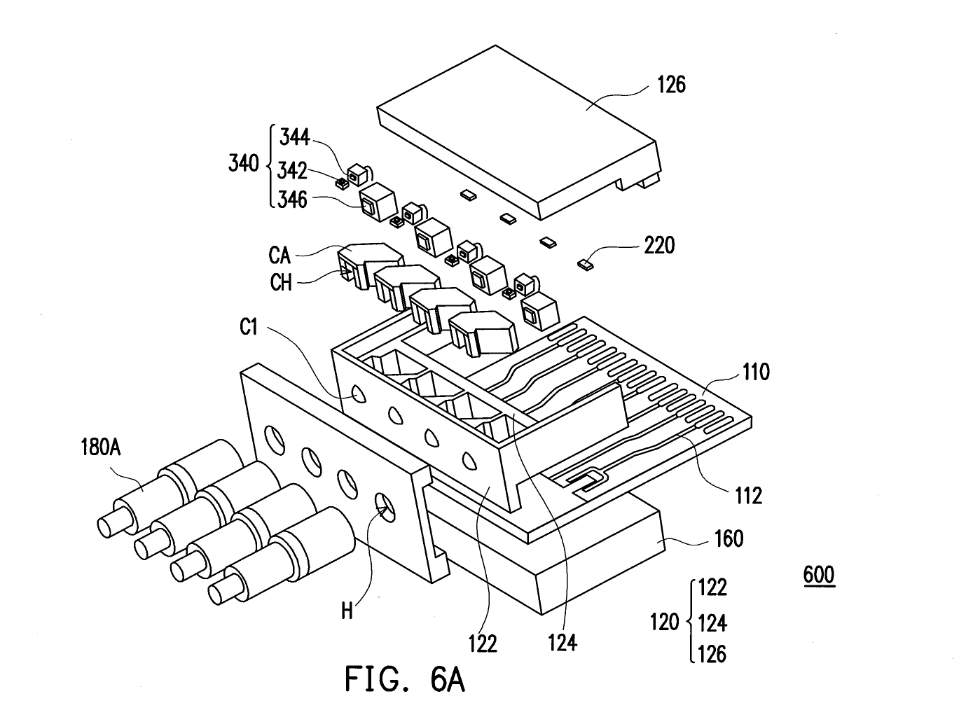

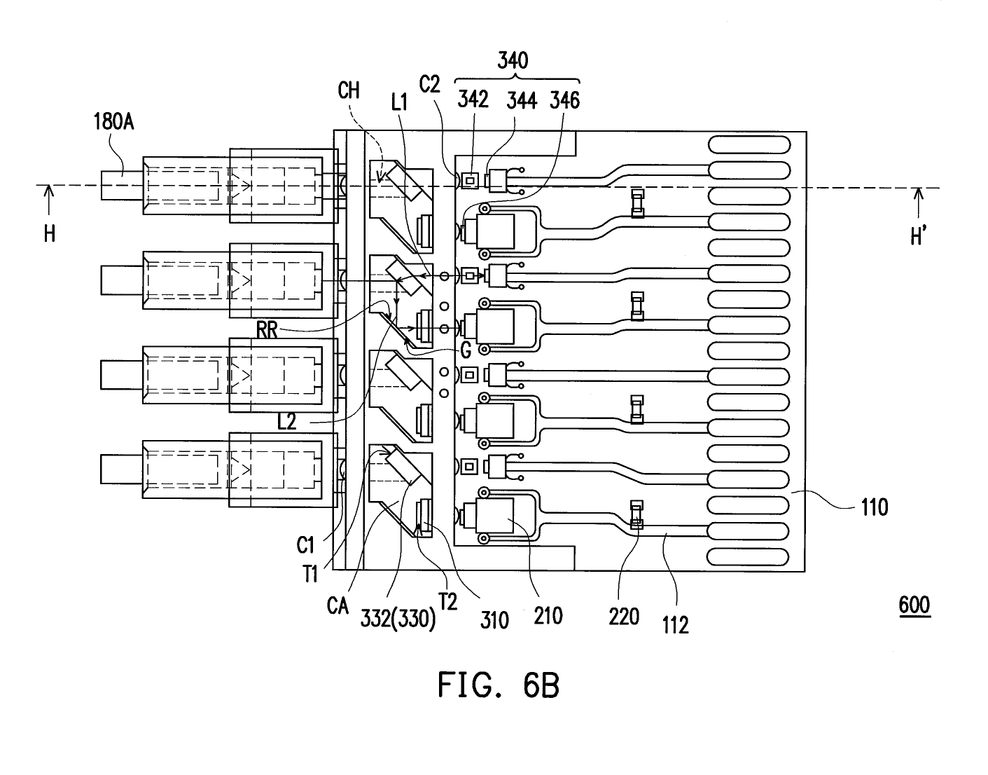

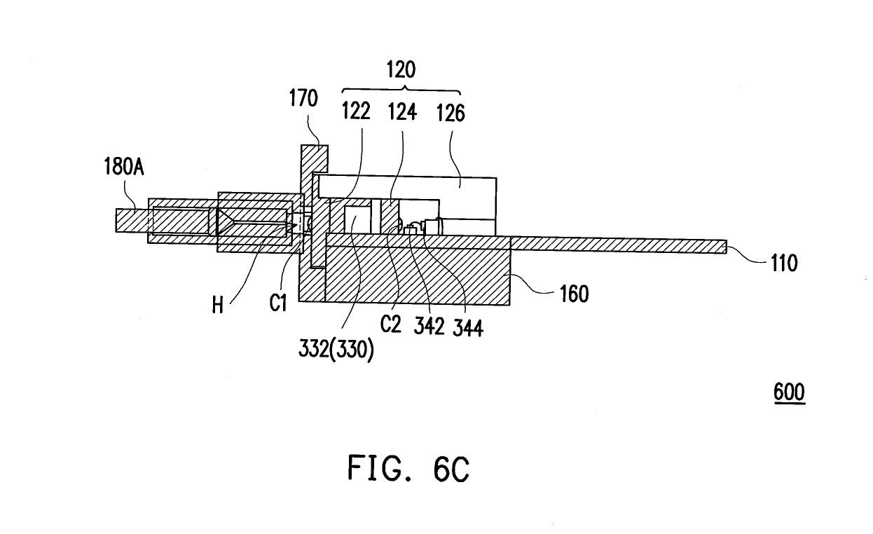

FIG. 6A is an exploded view of a hybrid integrated optical sub-assembly according to the sixth embodiment of the invention. FIG. 6B is a top view of FIG. 6A. FIG. 6C is a cross-sectional view along the section line H-H′ in FIG. 6B. Referring to FIG. 6A to FIG. 6C, a hybrid integrated optical sub-assembly 600 is similar to the hybrid integrated optical sub-assembly 500 of FIG. 5A to FIG. 5C, and similar elements are labeled with the same reference numerals and are not repeated herein.

The main difference between the hybrid integrated optical sub-assembly 600 and the hybrid integrated optical sub-assembly 500 is, the number of the optical isolation unit 310 of the hybrid integrated optical sub-assembly 600 is N, and the hybrid integrated optical sub-assembly 600 further includes an N number of carriers CA. The carriers CA are located in a region surrounded by the beam 124 and the frame 122, and each of the carriers CA has a first fixing groove T1, a second fixing groove T2, a connection hole CH, and a reflection surface RR. The first fixing groove T1 houses one of the beam splitting units 332, and the second fixing groove T2 houses one of the optical isolation units 310. The connection hole CH is a hollow structure, and the optical transmission medium of the connection hole CH is air. The connection hole CH connects the first fixing groove T1 and is located between the first fixing groove T1 and one of the first lens elements C1, wherein the second beam L2 from one of the first lens elements C1 passes through the connection hole CH and is transmitted to one of the beam splitting units 332 housed in the first fixing groove T1, then is reflected by one of the beam splitting units 332 and the reflection surface RR in order and transmitted to the optical isolation unit 310 housed in the second fixing groove T2, and then passes through the optical isolation unit 310 and the corresponding second lens element C2 in order and is transmitted to the corresponding light-detecting element 346.

In the present embodiment, a gap G exists between the reflecting surface RR and the beam 124. As a result, the second beam L2 transmitted to the reflection surface RR can be transmitted toward the direction of the optical isolation unit 310 via total reflection. The material of the carriers CA is, for instance, engineering plastic, but is not limited thereto.

The direction of the second beam L2 is changed via total reflection, and the light-detecting element 346, the light-emitting unit 342, and the power-detecting element 344 can be disposed at the same side of the beam 124. As a result, the configuration space of the elements can be enhanced.

In summary, via the disposition of the photoelectric conversion elements on the substrate, an additional packaging process for the photoelectric conversion elements can be omitted. As a result, the volume of the hybrid integrated optical sub-assembly can be effectively reduced, thus facilitating the reduction of manufacturing costs of the hybrid integrated optical sub-assembly. Moreover, since the area occupied by each of the photoelectric conversion elements can be effectively reduced, under the premise of a fixed area of the substrate, more photoelectric conversion elements and corresponding optical elements can be disposed on the substrate, such that the light signal transmission capacity per unit area of the hybrid integrated optical sub-assembly can be effectively increased. Furthermore, by integrating the lens elements (including the first lens elements and the second lens elements) to the shell, and by accurately fixing the optical processing unit and the photoelectric conversion elements on a preset optical path via alignment structures, not only the alignment and assembly process of the lens elements can be omitted, optical path correction steps of the corresponding lens elements, the optical processing unit, and the photoelectric conversion elements may also not omitted. As a result, the number and the difficulty of optical path correction can be reduced.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

1. A hybrid integrated optical sub-assembly, comprising:
a substrate;
a shell disposed on the substrate, wherein the shell comprises a frame and a beam connected to the frame, the frame has at least one first lens element, and the beam has at least one second lens element, wherein the frame and the beam are one piece, and the at least one first lens element and the at least one second lens element are parallel;
an optical processing unit located between the at least one first lens element and the at least one second lens element; and
a plurality of photoelectric conversion elements disposed on the substrate, and the at least one second lens element is located between the optical processing unit and the photoelectric conversion elements.

2. The hybrid integrated optical sub-assembly of claim 1, wherein the substrate is a printed circuit board, a ceramic substrate, or a metal composite material substrate.

3. The hybrid integrated optical sub-assembly of claim 1, wherein the substrate has a circuit thereon, and the hybrid integrated optical sub-assembly further comprises:
an integrated circuit and an electrical component electrically connected to the circuit.

4. The hybrid integrated optical sub-assembly of claim 1, wherein the substrate comprises a plurality of alignment structures.

5. The hybrid integrated optical sub-assembly of claim 1, wherein the frame and the beam of the shell are one piece.

6. The hybrid integrated optical sub-assembly of claim 1, wherein the frame has a first alignment structure, the beam has a second alignment structure, the first alignment structure and the second alignment structure have complementary shapes, and the frame and the beam are assembled together via the first alignment structure and the second alignment structure.

7. The hybrid integrated optical sub-assembly of claim 1, wherein a material of the shell is engineering plastic.

8. The hybrid integrated optical sub-assembly of claim 1, wherein the shell further comprises an upper cover, the frame and the beam are located between the upper cover and the substrate, and the optical processing unit is disposed on the substrate.

9. The hybrid integrated optical sub-assembly of claim 8, wherein the upper cover, the frame, and the beam are one piece.

10. The hybrid integrated optical sub-assembly of claim 8, wherein the upper cover is removably disposed on the frame and the beam.

11. The hybrid integrated optical sub-assembly of claim 10, wherein a material of the upper cover comprises a metal.

12. The hybrid integrated optical sub-assembly of claim 1, wherein the optical processing unit is indirectly disposed on the substrate via a carrier.

13. The hybrid integrated optical sub-assembly of claim 12, wherein the carrier, the frame, and the beam are one piece.

14. The hybrid integrated optical sub-assembly of claim 1, wherein the first lens element is a lenticular lens or a plano-convex lens, and the second lens element is a lenticular lens or a plano-convex lens.

15. The hybrid integrated optical sub-assembly of claim 1, wherein a number of the at least one first lens element is one, a number of the at least one second lens element is N, and the photoelectric conversion elements comprise an N number of light-emitting units and an N number of power-detecting elements, wherein each of the light-emitting units is respectively located between one of the second lens elements and one of the power-detecting elements, the light-emitting units emit an N number of beams, wavelengths of the N number of beams are different, the optical processing unit is adapted to merge the N number of beams into a first beam and transmit the first beam to the first lens element, the optical processing unit comprises at least one reflection unit and an N number of beam splitting units, each of the beam splitting units is respectively located between the at least one reflection unit and one of the second lens elements, and N is an integer greater than 1.

16. The hybrid integrated optical sub-assembly of claim 1, wherein a number of the at least one first lens element is one, a number of the at least one second lens element is N, the photoelectric conversion elements comprise an N number of light-detecting elements, each of the second lens elements is respectively located between the optical processing unit and one of the light-detecting elements, a second beam entering the hybrid integrated optical sub-assembly and containing different wavelengths is transmitted to the optical processing unit via the first lens element, the optical processing unit is adapted to split the second beam into an N number of sub-beams having different wavelengths, each of the sub-beams is respectively transmitted to one of the second lens elements, the optical processing unit comprises at least one reflection unit and an N number of beam splitting units, each of the beam splitting units is respectively located between the at least one reflection unit and one of the second lens elements, and N is an integer greater than 1.

17. The hybrid integrated optical sub-assembly of claim 1, wherein a number of the at least one first lens element is N, a number of the at least one second lens element is 2N, the photoelectric conversion elements comprise an N number of light-emitting units, an N number of power-detecting elements, and an N number of light-detecting elements, the N number of light-emitting units are disposed corresponding to an N number of the second lens elements, the N number of light-detecting elements are disposed corresponding to another N number of the second lens elements, each of the light-emitting units is respectively located between one of the power-detecting elements and one of the N number of second lens elements, each of the other N number of second lens elements is respectively located between the optical processing units and one of the light-detecting elements, wherein the N number of light-emitting units emit an N number of first beams, the N number of first beams are emitted from the hybrid integrated optical sub-assembly via the corresponding N number of second lens elements, the optical processing unit, and the N number of first lens elements in order, an N number of second beams enter the hybrid integrated optical sub-assembly and are transmitted to the N number of light-detecting elements via the N number of first lens elements, the optical processing unit, and the other N number of second lens elements in order, wavelengths of the N number of second beams are different from wavelengths of the N number of first beams, the optical processing unit comprises an N number of beam splitting units, the N number of beam splitting units are adapted to make the N number of first beams pass through and reflect the N number of second beams, or the N number of light-emitting units are adapted to make the N number of second beams pass through and reflect the N number of first beams, and N is an integer greater than or equal to 1.

18. The hybrid integrated optical sub-assembly of claim 17, further comprising:
one or an N number of optical isolation units, wherein the N number of second beams from the N number of beam splitting units are transmitted to the N number of light-detecting elements after passing through the one or N number of optical isolation units.

19. The hybrid integrated optical sub-assembly of claim 18, further comprising:
an N number of optical isolation units and an N number of carriers, wherein each of the carriers has a first fixing groove, a second fixing groove, a connection hole, and a reflection surface, the first fixing groove houses one of the beam splitting units, the second fixing groove houses one of the optical isolation units, the connection hole connects the first fixing groove and is located between the first fixing groove and one of the first lens elements, wherein the second beam from one of the first lens elements passes through the connection hole and is transmitted to one of the beam splitting units housed in the first fixing groove, then is reflected by one of the beam splitting units and the reflection surface in order and transmitted to the optical isolation unit housed in the second fixing groove, and then passes through the optical isolation unit and the corresponding second lens element in order and is transmitted to the corresponding light-detecting element.

20. The hybrid integrated optical sub-assembly of claim 19, wherein a material of the N carriers is engineering plastic.

21. The hybrid integrated optical sub-assembly of claim 1, wherein a number of the at least one first lens element is one, a number of the at least one second lens element is one, the photoelectric conversion elements comprise one light-emitting unit, one power-detecting element, and one light-detecting element, the light-emitting unit is located between the second lens element and the power-detecting element, the shell further comprises an upper cover, the upper cover is removably disposed on the frame and the beam, and the frame and the beam are located between the upper cover and the substrate, wherein the upper cover has a reflection surface and a third lens element located between the reflection surface and the light-detecting element, the light-emitting unit emits a first beam, the first beam is emitted from the hybrid integrated optical sub-assembly via the second lens element, the optical processing unit, and the first lens element in order, a second beam enters the hybrid integrated optical sub-assembly, the second beam passes through the first lens element and the optical processing unit in order, is reflected by the reflection surface, and passes through the third lens element and is transmitted to the light-detecting element.

22. The hybrid integrated optical sub-assembly of claim 1, further comprising:
a metal plate fixed to a side of the frame having the at least one first lens element, wherein the metal plate has at least one through-hole, and the at least one through-hole exposes the at least one first lens element; and
a fiber coupling mechanism fixed to the metal plate.

23. The hybrid integrated optical sub-assembly of claim 22, wherein the fiber coupling mechanism is a connector receptacle or a connector receptacle array.

24. The hybrid integrated optical sub-assembly of claim 22, wherein the fiber coupling mechanism is a fiber tail or a fiber tail array.

25. The hybrid integrated optical sub-assembly of claim 24, wherein the fiber coupling mechanism is a fiber tail array, and the hybrid integrated optical sub-assembly further comprises:
a fiber array connector connected to the fiber tail array.
